(19) United States
(12) Patent Application Publication
(10) Pub. No.: US 2001/0003350 A1
(43) Pub. Date: Jun. 14, 2001

(54) IRRIGATION OUTLET ATTACHMENT

(76) Inventors: NEALE GANDY, HONEYDEW (ZA); MICHAEL ANDREAS SCHOLZ, MORNINGSIDE (ZA)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/339,501

(22) Filed: Jun. 24, 1999

(51) Int. Cl. B67D 5/08

(52) U.S. Cl. 239/71; 239/74; 239/200

(57) ABSTRACT

This invention provides an attachment which may be secured to the closure of the housing for an irrigation outlet, the attachment including a plastics disc having a display surface for displaying information the disc being securable to the irrigation outlet.

### FIELD OF THE INVENTION

This invention relates to an irrigation outlet attachment and more particularly, but not exclusively, to an irrigation outlet attachment for use on irrigation outlets such as sprinklers on golf courses and the like.

### BACKGROUND TO THE INVENTION

Irrigation outlets such as sprinklers for lawns and the like are well known and widely used. Sprinklers for lawns which form fairways on golf courses and other lawns in gardens may be retracted into suitable housings when not in use. Such a sprinkler housing is usually covered when the sprinkler is not in use. This facilitates easy mowing of the lawn or the playing a sport thereon.

When a water supply to these sprinklers are turned on, water pressure causes the sprinkler to lift out of its housing. Such a housing may have a fixed cover which moves with the sprinkler or the container may have a hinged cover which pivots out of the way when water pressure lifts the sprinkler from its container.

A sprinkler connection means may also be provided in such a sprinkler housing. In this case sprinklers are not retracted underground, but a sprinkler is attached to the connection means when a lawn needs to be watered. Normally, these housings would have hingeable covers.

### OBJECT OF THE INVENTION

It is an object of this invention to provide an irrigation outlet attachment for an irrigation outlet as described above.

### SUMMARY OF THE INVENTION

In accordance with this invention there is provided an irrigation outlet attachment comprising a body having a display surface, the body being securable to an irrigation outlet for displaying information on the display surface.

Further features of the invention provides for the information to be promotional information and to be permanently secured to the surface; for the promotional information to be moulded or engraved on the surface, alternatively, for promotional information to be interchangable; and for the promotional information to be releasably adhesive stickers releasable securable to the surface.

There is provided for the surface to be parallel to a cover of an irrigation outlet when the body is secured to the irrigation outlet.

Still further features of one aspect of the invention provide for the body to be a disc; for the disc to have securing means for the securing means to be at least one aperture through the disc; and for the aperture to be situated in a recess in the disc.

Still further features of another aspect of the invention provide for the securing means to be an adhesive.

Still further features of another aspect of the invention provide for the body to be annular in shape.

These and other features of the invention are described below.

### BRIEF DESCRIPTION OF THE DRAWING

Embodiments of the invention are described below by way of example and with reference to the accompanying drawings, in which:

FlG. 1 shows a plan view of an irrigation outlet attachment in accordance with a first embodiment of the invention;

FIG. 2 shows a cross sectional side view of the attachment of FIG. 1; and

FIG. 3 shows a part cross sectional elevation of an attachment in use.

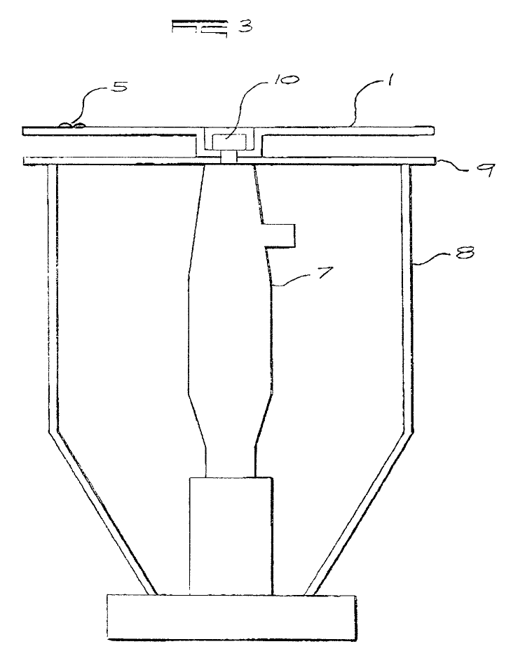

### DETAILED DESCRIPTION WITH REFERENCE TO THE DRAWINGS

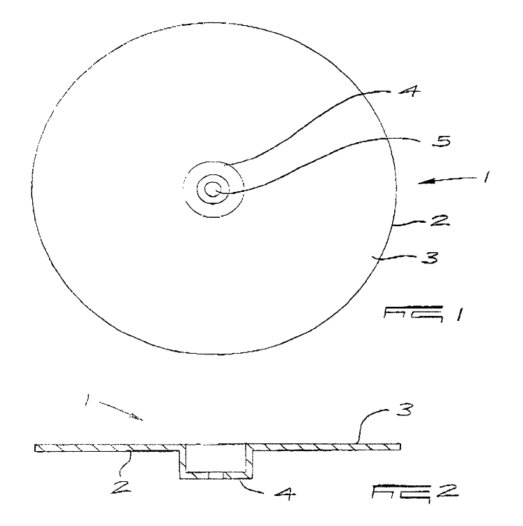

With reference to FIGS. 1 and 2, in which like features are indicated by like numerals, an attachment for an irrigation outlet is generally indicated by reference numeral (1).

The attachment (1) consists of a body (2) and a display surface (3).

In this embodiment, the body is a round disc having a centrally positioned recess (4). The recess has an aperture (5) therethrough to facilitate attachment of the body (1) to an irrigation outlet.

It will be appreciated that the body (2) does not have to be round in plan view but can be of any other convenient shape in plan view. The recess (4) can be enlarged to accommodate two or more apertures therethrough or more than one recess can be provided.

In this embodiment the display surface is a substantially flat surface. Again, it will be appreciated that, the display surface may be inclined so that body (1) is substantially V-shaped in cross-section. The display surface may of course be of any convenient shape to facilitate the display of promotional information (5) but it would normally be required that the surface be co-planar to a surrounding surface of the irrigation outlet. Promotional information (5) may also be moulded onto the display surface to form an integral part thereof or releasably adhesive stickers may be provided. The stickers can be interchangable to display different information, including distances etcetera.

In use, when an irrigation outlet such as a sprinkler (7) is retracted into its housing (8) or removed from its housing, the attachment mounted over a sprinkler or housing cover (9) by means of a machine screw (10). Advertising or promotional information (5) is displayed on the display surface (3) to promote a certain product or service.

This invention is not limited to the precise details as described herein. For example, displayed information may include other formation such as a distance measurement from a certain point and the like. Furthermore the body could be annular in shape to fit around an irrigation/sprinkler outlet.

What I/we claim as new and desire to secure by Letters Patent is:

1. An irrigation outlet attachment comprising a body having a display surface, the body being securable to an irrigation outlet for displaying information on the display surface.

2. An attachment as claimed in claim 1 in which the information is promotional information.

3. An attachment as claimed in claim 2 in which the promotional information is permanently secured to the surface.

4. An attachment as claimed in claim. 2 in which the promotional information is moulded on the surface.

5. An attachment as claimed in claim 2 in which the promotional information is etched on the surface.

6. An attachment as claimed in claim 2 in which the promotional information is interchangable.

7. An attachment as claimed in claim 6 in which the promotional information is on releasably adhesive stickers releasably securable to the surface.

8. An attachment as claimed in claim 1 in which the surface is generally parallel to a cover of an irrigation outlet when the body is secured to the irrigation outlet.

9. An attachment as claimed in claim 1 in which the body is a disc.

10. An attachment as claimed in claim 9 in which the disc has securing means.

11. An attachment as claimed in claim 10 in which the securing means includes at least one aperture through the disc.

12. An attachment as claimed in claim 11 in which the aperture is situated in a recess in the disc.

13. An attachment as claimed in any of the preceding claims in which the body is annular in shape.

14. An attachment as claimed in claim 10 in which the securing means is an adhesive.
